(19) United States
(12) Patent Application Publication
(10) Pub. No.: US 2012/0126565 A1
(43) Pub. Date: May 24, 2012

(54) SEAT DEVICE FOR MOTORCYCLES

(76) Inventors: Cristian Gustavo González, Mendoza (AR); Hugo Esteban Bianchi, Mendoza (AR)

(21) Appl. No.: 13/387,442

(22) PCT Filed: Aug. 11, 2010
(86) PCT No.: PCT/IB2010/053626

§ 371 Date: Jan. 27, 2012

(30) Foreign Application Priority Data
Aug. 14, 2009 (AR) P090103149

(51) Int. Cl. B60N 2/00

(52) U.S. Cl. 296/63

(57) ABSTRACT

A seat device for motor-vehicles that allows the displacement of the driver along with the seat from the center of gravity, wherein said device is composed of a driver's seat which is connected to the chassis of the motor-vehicle by a plurality of displacement means. The plurality of displacement means defines a condition of movement in a device of Cartesian coordinate system in relation to the longitudinal axis of the motor-vehicle.

### FIELD OF THE INVENTION

This invention refers to a seat device for motor-vehicles and is preferably applied to vehicle's driver seats requiring a displacement from the center of gravity of the driver together with said seat.

### BACKGROUND OF THE INVENTION

The device of seat displacement is presented in different mechanical options and, in its best degree of automatism, uses calculations for the displacement of the seat based on the capturing of sensors, different parameters and criteria in the use of said parameters (option panel). In this last case, it would be operated by a command central with which it is possible to adapt the device to the way and circumstance of driving and block the device, if necessary, while the basic device only deals with the mechanism without automation.

This invention is composed of two main parts:

A basic device which is composed of a mechanism that allows the displacement of the seat/s of a motorcycle in cross sense to the operation sense (including or not vertical displacement).

An advanced device which is composed of a mechanism that allows the displacement of the seat/s of a motorcycle in cross sense to the operation sense (including or not vertical displacement).

Said advanced device further comprises different sensors, such as tilt, speed, wind, moisture, temperature sensors and any other kind of sensors allowing the gathering of information to be supplied to a command central. In said command central, data related to the weight of the driver, the type of tires used, the pressure of said tires, the kind of floor, etc is also loaded. Thus, added to the variables measured by the sensors, the calculation of the seat displacement can be performed.

The movement of the seat, in the case of the optimized level, depends on the tilt of the motorcycle according to the rule established by the Command Central, which is in charge of transforming the signals captured by the sensors into orders to the Drive Element.

However, it is important to point out that the number and kind of sensors, as well as the options and way of using the data obtained through them, can vary according to the complexity of the device used and depending on the type of motorcycle in which is incorporated. This situation will depend on the technological level required or that can be included in the same since this would directly affect the final cost of the unit, thus being sometimes difficult to use an optimized device in motorcycles of cheap manufacture. In that case, it would be an intermediate device between the basic and the optimized ones probably limited to only one sensor connected to the medium for displacing the seat, without losing the advantages of the simplified use of the invention.

Whereas, the basic device is just a Mechanism that displaces the motorcycle seat and is activated through force exercised by the driver's body.

### SUMMARY OF THE INVENTION

is One of the objects of this invention is to reduce the tilt of the motorcycle, as a consequence of the displacement of the center of gravity, improving the adherence between the tire and the floor. Since in an ordinary motorcycle, due to the natural reflex of the brain in maintaining the body in a vertical position when taking a curve, it must be compensated with a higher tilt in the motorcycle.

Another purpose of this invention is the advantage of meeting the need of the skilled driver in achieving precision in the route, doing always exactly the same in the Advanced Device when taking a curve in a road. At present, motorcycles' drivers of conventional speed take the body out to the interior of the curve so that the motorcycle is less tilted, but the precision in doing so in a succession of curves varies since the same always depends on the driver's calculation and is affected by the tiredness after a long and exhausting route. This movable seat device allows the skilled drivers to maintain a high speed in curves with better precision, or, in other words, reduce the variables that contribute to make these mistakes, in this case the variable of the precise location of the body with respect to the motorcycle is eliminated, being always constant with this invention and safer.

Another object of this invention is to diminish the possibility of falling due to unskilled driving. For example, when a person begins to drive a motorcycle, if he/she does not have a professional training, he/she takes the curves with the motorcycle very tilted (something very usual is that the body is maintained very upright believing that this will confer more safety) which increases the risks of lack of adherence, which also reduces the possibilities of achieving closer manoeuvrings, sometimes very necessary in risky circumstances (for example when driving in routes on the right hand and the curve is towards the right, there is the tendency of getting out from the curve and meeting the vehicle in the opposite lane, causing an accident because the motorcycle does not allow further tilt and is late for the driver to place the body outward the seat to close in the curve), which would be reduced by the use of this invention.

It is important to mention that any person skilled in the art may note that there are other advantages, as that it teaches to correctly drive a motorcycle, in this way to know how to act even when is driving a conventional motorcycle and allow to understand the dynamic behavior of these vehicles, being this information necessary to improve the decisions taken in the daily driving.

With the use of sensors, it is also possible to position the seat slightly displaced in the case of driving in straight line with crossed strong wind.

### BRIEF DESCRIPTION OF THE DRAWINGS

For a better understanding of this invention, the object of this invention has been depicted in several figures, in which said object has been represented in one of the preferred embodiments, as an example, wherein:

FIG. 1 is an upper-bottom view of an illustrative mechanism for performing the functioning of the invention.

FIG. 2 illustrates the application of the invention in a motorcycle.

FIG. 3 is a frontal view that illustrates the application of the invention in a motorcycle.

FIG. 4 illustrates the application of the invention in a motorcycle and the tilting characteristics.

FIG. 5 illustrates six examples of motorcycles using alternatives of carrying out this invention.

### DETAILED DESCRIPTION OF THE INVENTION

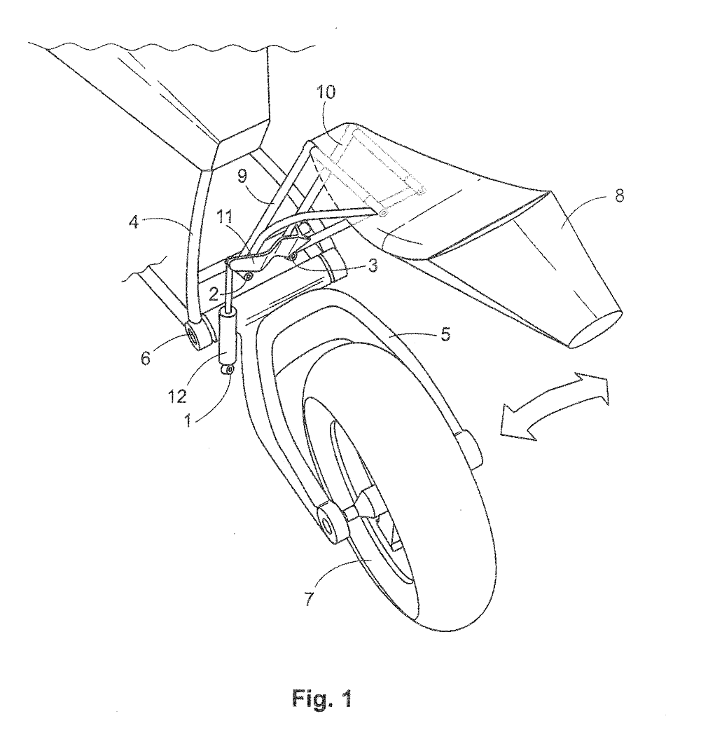

Regarding FIG. 1, it can be appreciated that in a fixed part of the motorcycle (4) that can be the chassis and/or engine—there exist two basic anchoring points, the axis (2) and (3) acting as the anchor of the arms (9) and (10), which in turn support the movable seat (8) and further, the axis (1) which serves as anchoring of the drive element (12). These arms (9) and (10) are moved by a driver (12) by means of a vehicle (11) to the movable arms (9) and (10). The signal that order the drive element (12) is controlled by a command central and its sensors. In order to complete the description of the figure, we can note that (5) is the lever that holds the rear wheel (7), said lever is anchored to the chassis or engine by the axis (6). In said figure, the seat displaced to the right with respect to the central longitudinal line of the motorcycle is observed. The drive element can also be controlled by a PID (proportional-integral-derivative controller).

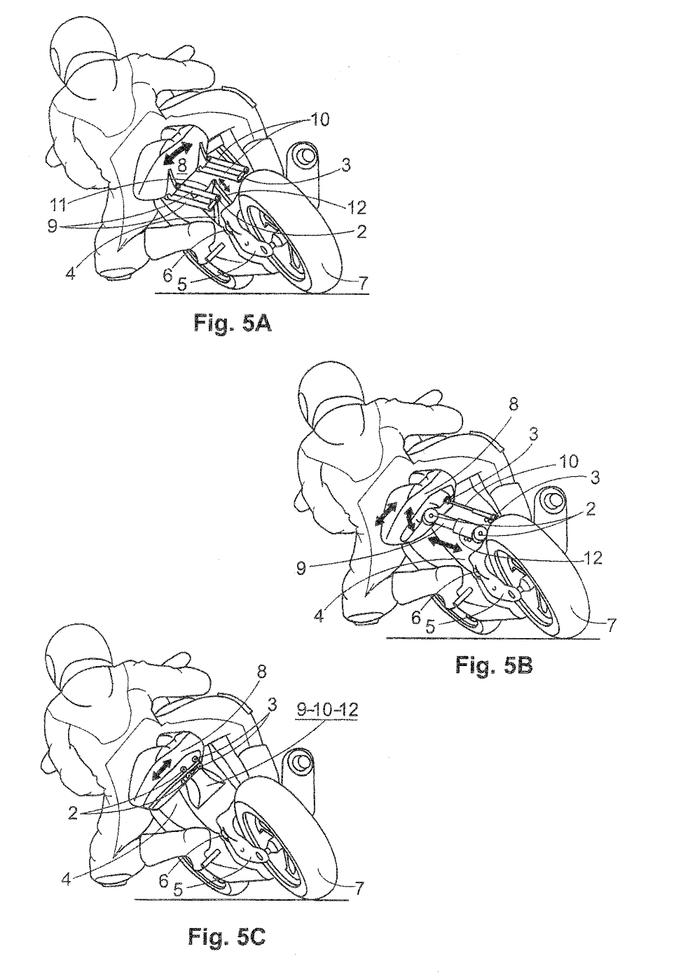

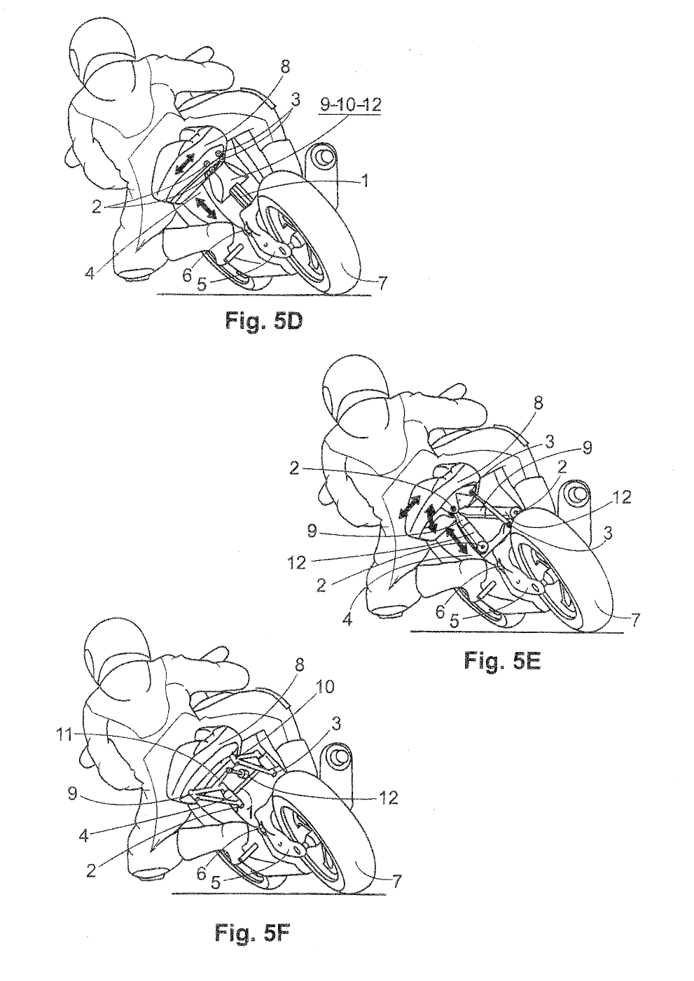

The only useful part remaining in the basic device is the seat movement device with a centering element that only carries the seat to the central position, which is only displaced by means of a force exercised by the driver's body and controlled by him and not by the control of a command central. This would be one of the most economic ways of manufacturing it, wherein the Drive Element (12) is replaced by a Centering Element (for example a double action piston that works in a compressed gas deposit or springs) and the advantages are reduced to the fact that the driver does not have to move from the seat when taking a curve since the seat goes with him to remind him that he has to displace the body when driving, however he would not have automatism of movement. This aspect is also applied to FIG. 5.

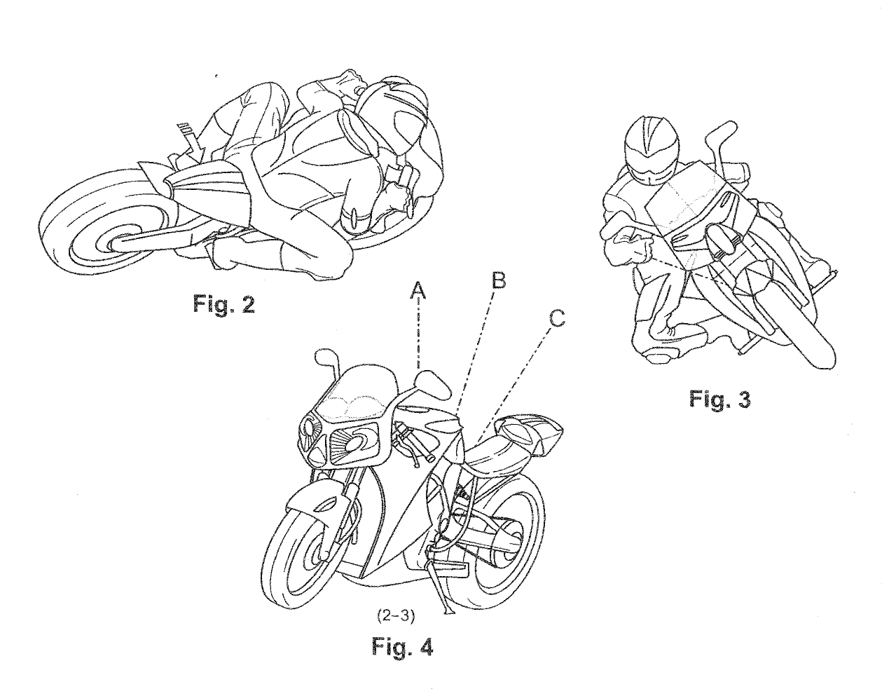

Regarding FIG. 2, in the same we can observe a motorcycle with a driver and the seat displaced to the right, in a top perspective view, with the motorcycle tilted almost to the maximum to the right; the arrow shows how the seat moves from its original position and, in consequence, the driver's body. Further, FIG. 3 is a front view of the situation described in FIG. 2 in which it is observed the motorcycle and how the seat is tilted or displaced with respect to the motorcycle, indicated with dotted lines the angle/distance of displacement. Regarding FIG. 4, it is a front-side perspective view of a motorcycle with the invention where three traces that indicate that trace A the vertical plan, trace B the tilting of the motorcycle with respect to the vertical plan; and trace C the tilting or displacement of the seat with respect to the motorcycle and according to its tilting regarding the vertical plan.

Referring to FIG. 5, different alternatives of producing the object of this invention are observed. The same will be indicated with the letters A, B, C, D, E and F and illustrated with a tilting toward the left for making more representative the functioning of the invention, all through the same principle, the displacement of the seat in crossing sense to the sense of the speed (including or not vertical displacement). There are six illustrative mechanisms to carry out said functioning, each of them with less or higher degree of movement regarding the other, shown as generic examples of mechanical possibilities in their building.

In Example A, the same solution and explanation as in FIG. 1 is observed.

In Example B, the same principle as in Example A is observed (parallelogram) although arms 9 and 10 are composed of extending elements that allow height and rotation variation over the imaginary longitudinal axis of the seat. It must be understood that if it is only activated (10), the seat simply rotates; if they are activated together, the seat rises and the temperatures goes down; and if only the drive element works over the arm (9) and the axis (2) lateral displacements from the seat are produced.

The drive element can also be included inside (9), thus (12) in the figure is pointing at (9), but can be also outside. Then, a conjunction of these movements open a range of possibilities regarding the options of operation guidelines.

In Example C, the same lateral movement (8) as in the rest is observed, basis of the invention, although not by means of arms but rails that work over the basic anchoring point (2) and (3) and where only one element replaces the other link, what in the figure is mentioned as (9-10-12).

The same mechanism of the example C is observed in the example D, plus a guide (1) fixed to (4) that allows to vary the height displacing the piece (9-10-12), which is the one that supports the seat (8).

A similar solution to the Example B is observed in the Example E but without the Drive Element since, when adding an extendible element (9), lateral displacements of the seat are possible with only contracting one of them. This also allows the variation of height, and along with (10), the rotation over the imaginary longitudinal axis of the seat. It must be understood that if (10) is only activated, the seat simply rotates; if (9-9) and (10) are activated together in the same sense, the seat rises and goes down in height.

In the Example F the same solution and explanation in the FIG. 1 and the example A are observed, with the detail that the mechanism is positioned in another angle.

In all the examples the reference number 5 indicates the lever that supports the rear wheel 7, which is anchored to the chassis or engine by means of the axis 6.

1. A seat device for motor-vehicles that allows the displacement of the driver from the center of gravity along with the seat, said device comprises the driver's seat which is connected to the chassis of the motor-vehicle by displacement means, wherein the device has a plurality of displacement means which define a movement condition in a device of Cartesian coordinate system in relation to the longitudinal axis of the motor-vehicle.

2. The device according to claim 1, wherein said plurality of displacement means is composed of a group of arms and axis that define a deformable parallelogram.

3. The device according to claim 2, wherein said deformed parallelogram is helped by an activation element.

4. The device according to claim 2, wherein said deformable parallelogram is helped by centering element.

5. The device according to claim 3, wherein said driving element is an hydraulic, pneumatic, electric actuator or a combination thereof.

6. The device according to claim 4, wherein said centering element is double action piston.

7. The device according to claim 4, wherein said centering element is a combination of elastic pieces such as springs and the like.

8. The device according to claim 1, wherein said plurality of displacement means is composed of a rail group.

9. The device according to claim 8, wherein said rail group is further comprised of a guide element.

10. The device according to claim 1, wherein said plurality of displacement means further comprises extendible elements.

11. The device according to claim 10, wherein said extendible elements define a height and rotation movement over the axial axis of the seat.

12. The device according to claim 1, wherein said plurality of displacement means are linked to a fixed portion of the motor-vehicle.
